(19) United States
(12) Patent Application Publication
(10) Pub. No.: US 2015/0061498 A1
(43) Pub. Date: Mar. 5, 2015

(54) Temperature Controlled High Output LED Lighting System

(71) Applicant: G.H.L. International, Inc., Cedarburg, WI (US)

(72) Inventors: Edgar C. Paffrath, Cedarburg, WI (US); Colin T. Grist, Madison, WI (US); John M. Lipscomb, Cedarburg, WI (US)

(21) Appl. No.: 14/476,698

(22) Filed: Sep. 3, 2014

Related U.S. Application Data
(60) Provisional application No. 61/873,036, filed on Sep. 3, 2013.

(51) Int. Cl. H05B 33/08

(52) U.S. Cl. CPC H05B 33/089; H05B 33/0851
USPC 315/113; 315/297

(57) ABSTRACT

A lighting system for providing high intensity lighting may include an LED system and a control system that controls the LED system based on a determined temperature to ensure that a minimum acceptable lighting value is provided at all times while thermally protecting the LED system. The high output lighting system has a lamp or luminaire equipped with the LED system producing a thermally regulated LED lighting system well suited for indoor and/or outdoor lighting applications such as portable and other light towers.

### CROSS REFERENCE TO RELATED APPLICATION

This application claims the benefit under 35 U.S.C. §119(e) of U.S. Provisional Application Ser. No. 61/873,036, filed on Sep. 3, 2013, the entirety of which is hereby expressly incorporated by reference herein.

### FIELD

The present invention is directed to luminaires and lighting systems and more particularly to high output luminaires and lighting systems employing light emitting diodes (LEDs) and LED modules.

### BACKGROUND

Lighting systems are known that require high intensity light output from lamps. These systems can be used in various indoor lighting applications that require a lot of illumination to brightly illuminate indoor spaces. Outdoor lighting applications that require a lot of illumination include various outdoor entertainment venues, as well as illuminated outdoor public areas such as parks and streets. Other outdoor lighting applications that require a lot of illumination include security and other lighting for commercial and residential buildings. Outdoor lighting with light towers is known for use at construction sites and various outdoor events that require a lot of illumination to brightly illuminate relatively large areas. To cover such relatively large areas, light towers include lights that are mounted to upper ends of tall masts so that light beams from the lights can sufficiently spread across and illuminate such large areas.

Most of these indoor and outdoor lighting systems that require high intensity light output from lamps include lamps that are positioned relatively high in the air and thus far from the areas being illuminated. Accordingly, high-power bulbs are required to sufficiently illuminate areas. Such bulbs, including metal halide and other bulbs, can consume large amounts of electrical power. In addition, the quality of the light or its Color Rendering Index (CRI) can produce light that gives the impression of illuminating poorly despite being very bright.

Light emitting diodes or LEDs are gaining popularity as lighting sources. Not only do LEDs consume less power, they have a long life, and can produce a better quality light at a lower brightness or lumen level. LEDs for high output usage tended to be provided as LED modules with LEDs mounted to circuit boards. LED modules have stringent maximum temperature operating requirements, above which the circuit boards of the LED modules can be damaged.

What is needed is a high brightness or high lumen output lighting system capable of outdoor use that uses LED modules in a manner that produces reliable and stable operation.

### SUMMARY

The present invention is directed to a thermally responsive LED lighting control system that includes a LED module lighting system formed of a plurality of LED modules in close proximity to one another in communication with a controller that controls operation of the LED module lighting system based on temperature to ensure that a minimum amount of light is outputted at all times by LED modules of the LED module lighting system while thermally protecting LED modules of the LED module lighting system. In a preferred LED lighting control system, multiple LED modules of a LED module lighting system are carried by a luminaire or lamp and a sensed or measured temperature of the luminaire or lamp is used by the controller in controlling LED module operation in a manner that maintains a minimum amount of light output from the luminaire or lamp during operation.

In one such LED lighting control system, the LED module lighting system of a lamp or luminaire has at least a plurality of pairs, i.e., at least three, LED modules adjacent one another with controller using at least one temperature sensed or measured at or adjacent at least one of the LED modules in controlling operation of at least one of the LED modules to maintain a minimum light output while thermally protecting the modules. In such a preferred LED lighting control system, the LED module lighting system of a lamp or luminaire has at least a plurality of pairs, i.e., at least three, LED modules adjacent one another with the controller using at least one temperature sensed or measured at or adjacent at least one of the LED modules in controlling operation of at least one of the LED modules but less than all of the LED modules of the LED module lighting system to maintain a minimum light output while at the same time thermally protecting the modules.

The present invention also is directed to a high output lighting system formed of a plurality of luminaires or lamps each equipped with a LED module lighting system having a plurality of LED modules controlled by a thermally responsive controller of a LED lighting control system that senses or measures a temperature of each luminaire or lamp to control operation of the LED modules of each luminaire or lamp in a manner that maintains minimum light output while also providing LED module thermal protection. In one high output lighting system

The LED module lighting system has a plurality of LED modules carried by a luminaire or lamp. Each of the multiple LED modules has a plurality of LEDs arranged to project light out of the lamp. In a preferred embodiment, each of the multiple LED modules has at least a plurality of pairs, i.e., at least three, rows of LEDs with each row of LEDs having at least a plurality of pairs of LEDs. The LED module lighting system defines a heat detection zone at which heat is detected to define a detected temperature inside of the lamp. A control system is connected to the LED module lighting system for controlling an amount of electrical power delivered to at least one of the multiple LED modules to regulate temperature of the LED module lighting system based at least in part on the detected temperature inside of the lamp. Such a control system preferably enables operation of the multiple LED modules of the LED module lighting system to be controlled or regulated in order to optimize light output under high temperature operating conditions.

The heat detection zone may be defined upon at least one of the multiple LED modules. The heat detection zone may be defined within a heated zone of the at least one of the multiple LED modules receiving heat energy from the LEDs of the respective at least one of the multiple LED modules. A temperature sensor may be mounted at the heat detection zone of the at least one of the multiple LED modules. The temperature sensor may be defined by a thermocouple mounted to the at least one of the multiple LED modules. A first one of the multiple LED modules may be controlled based on the detected temperature inside of the lamp and a second one of the multiple LED modules is not controlled based on the detected temperature inside of the lamp. The multiple LED modules may define a pair of unregulated LED modules that are not controlled based on the detected temperature inside of the lamp. The control system may modulate at least one regulated LED module by controlling the amount of electrical power delivered to the at least one regulated LED module, and the at least one regulated LED module may be arranged between the pair of unregulated LED modules. The at least one regulated LED module may be defined by a pair of regulated LED modules that is arranged between the pair of unregulated LED modules. This may allow for a relatively compact configuration of a temperature controlled high output LED lighting system.

A heatsink may be mounted to and extend outwardly with respect to the lamp and be connected to the multiple LED modules for dissipating heat from the LED system. The heat detection zone may be defined within a heated zone of at least one of the multiple LED modules receiving heat energy from the LEDs of at least one of the multiple LED modules such that the detected temperature inside of the lamp corresponds to a detected temperature of the first LED module. The heatsink may include a wall defining upper and lower portions. Heated zones of adjacent LED modules may be on opposing ones of the upper and lower portions of the wall of the heatsink. Each of the LED modules may include a connector coupling the respective LED module to conductors extending to the control system. The connectors of adjacent LED modules may be on opposing ones of the upper and lower portions of the wall of the heatsink. The heatsink may have a front wall and the lamp may define a reflector with a reflector back wall. The heatsink front wall and the reflector back wall may engage so as to transmit heat between each other. The reflector back wall may include an opening and the multiple LED modules may be arranged within the opening of the reflective back wall. This may allow for a high output LED lighting system that can efficiently dissipate system heat.

A method of providing high intensity lighting with a lighting system to a location to be illuminated may include delivering electrical power to a first LED module mounted in a lamp to illuminate the first LED module. Electrical power is delivered to a second LED module mounted in the lamp to illuminate the second LED module. A temperature inside of the lamp is detected. An amount of electrical power delivered may be reduced more to one of the first and second LED modules than the other one of the first and second LED modules based at least in part on the detected temperature inside of the lamp to reduce the temperature inside of the lamp. This may provide a method of providing high intensity lighting to ensure that a minimum acceptable lighting value is provided at all times while thermally protecting the LED system.

The high output lighting system may include LED modules that can be used with a light tower. The lamp may allow for long durations of high output from the LED modules by way of a temperature management system. The temperature management system allows some of the LED modules to remain energized and emit light at all times during use and control other LED modules based on detected temperature(s). This may ensure that a minimum acceptable lighting value is provided at all times by the high output lamp when the light tower is activated while thermally protecting the LED modules.

The lamp may include a light fixture with a casing having a reflector defining a reflector opening from which light is directed from the reflector toward a location to be illuminated. A heatsink may extend from the reflector and have a wall facing toward the reflector opening. Multiple LED modules may be supported by a wall of a heatsink. Each of the LED modules may include LEDs arranged to project light out of the light fixture opening and a chip operably connected to the LEDs such as a separate chip upon which each LED is mounted for delivering electrical power to the LEDs. Each chip may define a location of direct heat transfer to a board or substrate of the respective LED module, whereby a heated zone is defined peripherally about and across a collective matrix of LED chips at each LED module, defining a zone at which heat is concentrated for the respective LED module. The chips of the LED modules may be arranged with respect to each other so that the heated zones are spaced from each other relative to the wall of the heatsink. The lamp may define a light of a light tower, such as a portable light tower. This may allow for distributing localized concentrations of high heat transmission from the LED modules to the heatsink across a relatively large surface area of the heatsink. This may allow for efficient cooling of LED modules in a light tower having LED-based lights.

A first one of the multiple LED modules may be controlled based on a temperature within the lamp and a second one of the multiple LED modules may not be controlled based on the temperature within the lamp. The control of the first one of the multiple LED modules may be done based on the temperature of the first one of the multiple LED modules itself.

The multiple LED modules may define a pair of unregulated LED modules that are not controlled based on a temperature of the respective LED modules and at least one regulated LED module that is controlled based on a temperature of the respective at least one LED module. The at least one regulated LED module may be arranged between the pair of unregulated LED modules. The multiple LED modules may define a pair of regulated LED modules that are controlled based on a temperature of the pair of regulated LED modules. The pair of regulated LED modules may be arranged between the pair of unregulated LED modules or the regulated and unregulated LED modules may be arranged in an alternating sequence with respect to each other. Controlling fewer than all of the LED modules may allow for running fewer wires from the LED modules to a power source that would otherwise be required if all of the LED modules were regulated.

Temperature of the LED modules may be controlled while ensuring that the lamp emits a sufficient amount of light by including at least one regulated LED module and at least one unregulated LED module arranged within a reflector of a light tower for directing light to a location to be illuminated. Electrical power may be delivered to the at least one regulated LED so as to illuminate the at least one regulated LED. Electrical power may be delivered to the at least one unregulated LED module so as to illuminate the at least one unregulated LED module. A temperature within the lamp may be detected. An amount of electrical power delivered to the regulated LED module(s) may be reduced based at least in part on the detected temperature while maintaining an amount of electrical power delivered to the unregulated LED module(s). The reduction may be an on/off type modulation or a throttling-type or dimming-type reduction in the amount of electrical power delivered to the regulated LED module(s).

The wall of the heatsink may define upper and lower portions, and heated zones of adjacent LED modules may be on opposing ones of the upper and lower portions of the wall of the heatsink. The wall of the heatsink may define a heatsink front wall and the reflector may include a reflector back wall. The heatsink front wall and the reflector back wall may engage so as to transmit heat between each other. The reflector back wall may include an opening in which the multiple LED modules are arranged. This may allow for a compact configuration with efficient heat transfer between the heatsink and other components of the lamp.

The heatsink may cover the back wall opening of the reflector and be secured to the reflector by multiple fasteners that are spaced from each other and are arranged outwardly of the back wall opening of the reflector. A gasket may be arranged to provide a watertight seal between the heatsink and the reflector. The gasket may be arranged outwardly of the back wall opening on the reflector and the multiple fasteners. A backing plate may be arranged toward the reflector opening so that the reflector back wall is sandwiched between the backing plate and the heatsink. This may allow for a liquid tight seal and a relatively large amount of face-to-face surface area between a plate and reflector. Providing a gasket outboard of the mounting bolts may help maintain seal at the bolts, allowing for use of a gasket with a relatively small cross-sectional area. This may allow for a high clamping force and deflection of the gasket and may relatively reduce a thermal barrier between a clamping engagement defined between the heatsink and the reflector and relatively increase a surface area of the engaging surfaces of the heatsink and reflector. This may allow for a thermal transfer relationship between the heatsink and the reflector which may allow the reflector to perform supplemental heat dissipation.

A pair of mounts may be arranged on opposing sides of the reflector toward the reflector back wall with a pivot axis of the lamp defined through an intermediate portion of the pair of mounts. Each of the mounts may define front and back edges and the pivot axis of the lamp may extend closer to the back edges than the front edges of the mounts. This may allow for the center of gravity of the lamp to be aligned with the pivot axis of the lamp so as to minimize forces required to resist offset center of gravity torque components which may otherwise occur with a heatsink extending rearwardly from the lamp.

In one preferred method of operating a high intensity lighting system having at least one lamp with a plurality of light emitting LED modules to maintain a desired minimum light output level from the lamp under high temperature operating conditions, electrical power is delivered to the LED modules causing light to be outputted from the lamp, a temperature of the lamp is detected, and the delivery of the electrical power to the LED modules is controlled when the detected lamp temperature exceeds a threshold temperature that provides enough electrical power to maintain a light output level at or above the minimum light output level while enabling cooling to occur that reduces the detected temperature to below the threshold temperature. In one such preferred control method, electrical power delivered to at least one of the LED modules is reduced while the detected temperature is monitored while electrical power delivered to at least one other LED module is not reduced enabling cooling of one or more LED modules of the lamp to occur while causing the lamp to output a desired minimum light output level while this is being done. If desired, delivery of electrical power to at least one of the LED modules of a lamp can be done while delivery of electrical power is maintained to at least one of the other LED modules of the lamp can be done when controlling electrical power delivery when a lamp temperature greater than the threshold temperature is detected.

When electrical power is delivered at the same time to each one of the plurality of LED modules of a lamp, such as during lamp startup and when the detected temperature is below the threshold temperature, light is outputted at the same time from all of the LED modules of the lamp causing the lamp to output light at a first lumen output level that is greater than the minimum light output level, i.e., minimum lumen output level. When the same amount or magnitude of electrical power is delivered to each one of the plurality of LED modules of a lamp at the same time, such as during lamp startup and when the detected temperature is below the threshold temperature, a maximum lumen output level of light is outputted from each LED module of the lamp at the same time causing the lamp to output light at a maximum lumen output level that is greater than the minimum light output level, i.e., minimum lumen output level.

A controller preferably is used to monitor lamp temperature preferably by detecting a temperature of the lamp within a zone of or onboard the lamp that encompasses at least one of the LED modules of the lamp and which can encompass a plurality of the LED modules of the lamp. Where one or more of the LED modules of the lamp are equipped with an onboard temperature sensor, e.g., thermocouple, temperature detection can be accomplished by the controller monitoring the temperature of at least one of the LED modules by detecting the temperature of the onboard temperature sensor of at least one of the LED modules. In one preferred embodiment, a temperature sensor. e.g., thermocouple, used to detect lamp temperature can be mounted to part of the lamp adjacent to one or more of the LED modules. Where mounted to part of the lamp, such a temperature sensor can be mounted to a housing or fixture of the lamp close enough to at least one of the LED modules of the lamp to enable detected lamp temperature to be indicative of the temperature of at least one of the adjacent LED modules. Such a temperature sensor preferably is located close enough to at least one of the LED modules of the lamp and preferably is located close enough to all of the LED modules of the lamp so that the temperature sensor is used to detect the temperature of the lamp in a heat detection zone encompassing at least one of the LED modules of the lamp that preferably encompasses all of the LED modules of the lamp or a heat detection zone within a heated zone encompassing at least one of the LED modules of the lamp that preferably encompasses all of the LED modules of the lamp.

### DRAWING DESCRIPTION

Preferred exemplary embodiments of the invention are illustrated in the accompanying drawings in which like reference numerals represent like parts throughout, and in which:

FIG. 1 is a simplified schematic front elevation view of a temperature controlled high output lighting system constructed in accordance with the present invention;

FIG. 2 is a perspective view of a portable light tower equipped with a lighting system constructed in accordance with the present invention;

FIG. 3 is a perspective view of the portable light tower of FIG. 1 shown in a first storage or transport position;

FIG. 4 is a close-up perspective view of a lighting system of the portable light tower of FIG. 2;

FIG. 5 is a perspective exploded view of a lighting system in accordance with the present invention;

FIG. 6 is a perspective exploded view of a variant of the lighting system of FIG. 5;

FIG. 7 is a partially schematic simplified front elevation view of a lighting system in accordance with the present invention;

FIG. 8 is a partially schematic simplified front elevation view of a variant of the lighting system of FIG. 7;

FIG. 9 is a partially schematic simplified front elevation view of another variant of the lighting system of FIG. 7;

FIG. 10 is a partially schematic simplified front elevation view of a variant of the lighting system of FIG. 9; and

FIG. 11 is a diagram depicting a method of using a lighting system in accordance with the present invention.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

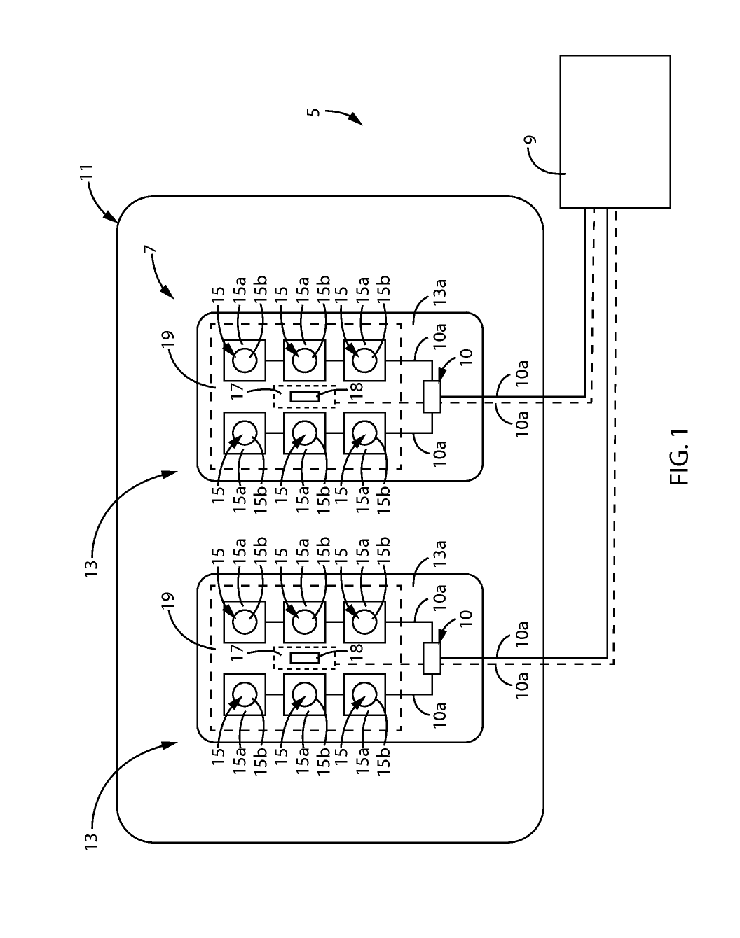

FIG. 1 illustrates a simplified schematic representation of a thermally responsive LED lighting control system 5 for use with indoor and/or outdoor lighting systems and applications having an LED lighting system 7 and a temperature responsive lighting power control system 9. Control system 9 is operably connected to and controls the LED lighting system 7 based on temperature to ensure that a minimum acceptable lighting output value is provided at all times while thermally protecting the LED lighting system 7, as explained in greater detail elsewhere herein. The LED lighting control system 5 includes a luminaire or lamp 11, only a portion of which is shown in FIG. 1, in which the LED lighting system 7 is mounted. The LED lighting system 7 includes multiple LED modules 13 mounted inside of the luminaire 11. Each of the LED modules 13 has an electrical connector 10 and electrical conductors 10a extending from and electrically connecting the control system 9 to a matrix or array of LED chip assemblies 15 mounted to a substrate or board 13a of each corresponding LED module 13. Each of the LED chip assemblies 15 includes an LED chip 15a which is mounted to the board 13a and an LED 15b mounted to the LED chip 15a that emits light when electrically powered.

In at least one preferred embodiment, each LED module 13 of LED lighting system 7 has a plurality of pairs, i.e., at least three, of rows with each one of the rows having a plurality of pairs, i.e., of LEDs 15b. In such a preferred embodiment, each one of the LEDs 15b can be part of an LED chip assembly 15 formed of a chip 15a that carries LED 15b.

Still referring to FIG. 1, a heat detection zone 17 is defined within the luminaire 11 from which a temperature inside of the luminaire 11 is detected and used by the control system 9 to regulate power to at least one of the LED modules 13 to thermally regulate one or more of the LED modules 13. Based on the detected temperature inside of the luminaire 11, the control system 9 regulates the amount of electrical power delivered to at least one of the LED modules 13 in controlling the temperature of the LED system 7 to thermally protect the LED modules 13. Based on the detected temperature inside of the luminaire 11, the control system 9 controllably reduces the amount of electrical power delivered to at least one of the LED modules 13 to reduce the temperature of the LED system 7 if the detected temperature becomes too high.

In a preferred method of controlling temperature, the control system 9 regulates the amount of electrical power delivered to at least one of the LED modules 13 of the luminaire 11 by attenuating the voltage of the delivered electrical power in response to detected temperature. In another preferred method of controlling temperature, the control system 9 regulates the amount of electrical power delivered to at least one of the LED modules 13 of the luminaire 11 by attenuating the current of the delivered electrical power in response to detected temperature. If desired, the control system 9 can selectively vary or control the amount of electrical power delivered to at least one of the LED modules 13 of the luminaire 11 using pulse width modulation (PWM) to maintain a desired minimum light output while thermally regulating one or more of the LED modules 13.

The control system 9 can be or include a regulated power supply capable of receiving and regulating electrical power from a power source at one voltage and/or amperage to deliver the electrical power to at least one of the LED modules 13 of the luminaire 11 at another voltage and/or current. If desired, the control system 9 can be electrically connected to a separate regulated power supply (not shown) capable of receiving and regulating electrical power from a power source at one voltage and/or amperage to deliver the electrical power to at least one of the LED modules 13 of the luminaire 11 at another voltage and/or current. As discussed in more detail below, the power source from which electrical power is ultimately supplied can be in the form of utility electrical power, e.g., 110-125 volts AC, one or more batteries, e.g., 6 volt and/or 12 volt lead-acid and/or gel batteries, an electrical generator that supplies electrical power at voltages ranging from about 12 volts to 125 volts AC, one or more solar cells, or the like.

In the embodiment shown in FIG. 1, the heat detection zone(s) 17 is defined at a location in the luminaire 11 where at least one of the LED modules 13 and a temperature sensor 18 is disposed. The temperature sensor 18 can be a thermocouple or another type of sensor from which a temperature can be sensed or measured that is located within the heat detection zone(s) in close enough proximity to at least one adjacent LED module 13 that the detected temperature provided by the sensor 18 is indicative or representative of an LED module operating temperature of the at least one adjacent LED module 13. While the temperature sensor 18 can be mounted directly to the luminaire 11 or located between the at least one adjacent LED module 13 and the luminaire 11, the temperature sensor 18 preferably is disposed onboard the at least one adjacent LED module 13.

Where the temperature sensor 18 is disposed onboard an adjacent LED module 13, the temperature sensor 18 can be a thermocouple or other type of temperature sensor located within a heat detection zone 17 located close enough to a heated zone 19 of the adjacent LED module 13 that heats up to a temperature of at least ten degrees Fahrenheit above the ambient temperature of air outside the luminaire 11 when electrical power is supplied to the LED module 13.

As is also shown in FIG. 1, the heated zone 19 of the LED module 13 is defined by an area corresponding to a portion of the board 13a of the LED module 13 that increases in temperature more than other portions of the LED module 13 when electrical power is delivered to the module 13 at a sufficient voltage and amperage to cause the module 13 to emit light. With continued reference to FIG. 1, the heated zone 19 is shown as a dashed line that bounds or encircles the outer periphery of the matrix or array of LED chip assemblies 15 of the LED module 13. The heated zone 19 is defined peripherally about and extends across the collective matrix or array of all of the LED chip assemblies 15 of the LED module 13.

In one preferred embodiment, the heated zone 19 is an area of the LED module 13 that extends peripherally around all of the LEDs 15b of the LED module 13 and encompasses the portion of the LED module 13, namely the board 13a of the LED module 13, that heats up to a heats up to a temperature of at least five degrees Fahrenheit greater than the ambient temperature of air outside the luminaire 11 when electrical power is supplied to the LED module 13. In another preferred embodiment, the heated zone 19 is an area of the LED module 13 that extends peripherally around all of the LEDs 15b of the LED module 13 and encompasses that portion of the LED module 13, namely the board 13a of the LED module 13, that heats up to a heats up to a temperature of at least ten degrees Fahrenheit above the ambient temperature of air outside the luminaire 11 when electrical power is supplied to the LED module 13.

As is shown in FIG. 1, the shape of the heated zone 19 substantially conforms to that of the shape, e.g., outer peripheral shape, of the matrix or array of the LEDs 15b of the LED module 13. As such, the generally rectangular shape of each one of the heated zones 19 shown in FIG. 1 substantially conforms to or is substantially the same as the generally rectangular shape of the matrix or array of LEDs 15b of the corresponding module 13.

While the heat detection zone 17 of an LED module 13 can be located outside of the heated zone 19 of the module 13, the heat detection zone 17 is in thermally conductive communication with the heated zone 19 so that a temperature detected at such remote heat detection zone 17 correlates to a temperature of the heated zone 19 of the LED module 13 and preferably correlates to a detected temperature of the temperature sensor 18. Regardless of where the heat detection zone 17 and/or temperature sensor 18 is located within the luminaire 11, the control system 9 is configured to vary or modulate electrical power delivered to at least one of the LED modules 13 based on a detected temperature in the heat detection zone 17 in a manner that reduces the amount of electrical power delivered in order to reduce the temperature of at least one of the LED modules 13. The control system 9 is configured to do so while still supplying enough electrical power to at least one of the other LED modules 13 to substantially continuously maintain a minimum acceptable lumen or lux light output emitted from the luminaire 11. By throttling down the amount of electrical power supplied to at least one of the LED modules 13 in response to detected temperature while still supplying enough electrical power to at least one of the other LED modules 13 to maintain the desired minimum acceptable lumen or lux light output from the luminaire 11, effective operation of the luminaire 11 is maintained while thermally protecting the LED modules 13 by preventing them from overheating.

In a preferred embodiment and method of controlling a luminaire 11 having at least a plurality of LED modules 13, electrical power supplied to at least one of the LED modules 13 is throttled down or otherwise attenuated in proportion to the amount the detected temperature exceeds a predetermined threshold temperature thereby providing an opportunity to cool or reduce the operating temperature of at least one of the LED modules 13 of the luminaire 11. Once the detected temperature drops below the threshold temperature after cooling takes place, throttling or attenuation of electrical power delivered to each and every one of the LED modules 13 of the luminaire 11 ceases causing the luminaire 11 to resume full lumen or lux light output.

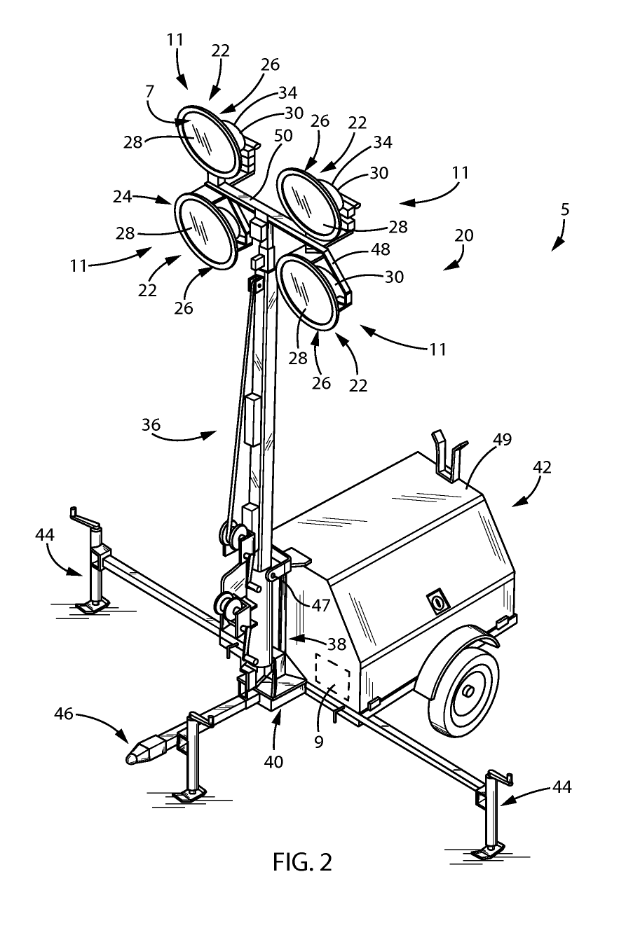

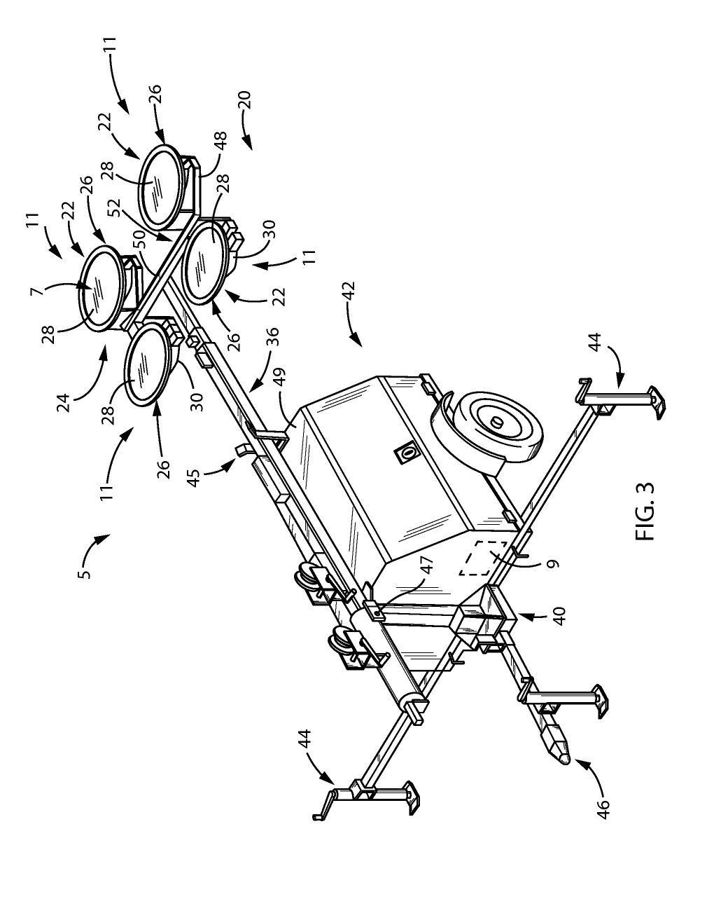

FIGS. 2 and 3 illustrate the thermally responsive LED lighting control system 5 incorporated into an exemplary but preferred high output lighting system in the form of an outdoor portable light tower 20. Light tower 20 is equipped with at least one and, typically, a plurality of luminaires 11 shown in FIGS. 2 and 3 as spaced apart outdoor tower lights 22 arranged in a bank or array 24 of lights 22 having a plurality of rows of lights 22 with each row of lights 22 having a plurality of lights 22. Each luminaire 11 or light 22 shown in FIGS. 2 and 3 includes a light fixture 26 with a substantially transparent lens 28 removably attached to a casing 29 having a reflector 30 providing a substantially weather tight enclosure in which a source of light, namely LED lighting system 7, is disposed. The light fixture casing 29 preferably is made of aluminum or an aluminum to produce a strong, weather resistant, corrosion resistant and lightweight luminaire 11 or light 22 that relatively efficiently conducts heat away from the LED modules 13 of the LED lighting system 7 during lighting system operation and helps dissipate the heat to the ambient air outside of the light fixture 26 that surrounds the fixture 26. In a preferred embodiment, the casing 29 and/or reflector 30 is cast of aluminum or an aluminum alloy. The lens 28 can be made of glass, such as tempered glass, but preferably is made of a plastic, preferably polycarbonate, but can be made of another suitable type of plastic.

The light tower 20 includes an upright mast 36 that can be of telescoping construction, such as is depicted in FIGS. 2 and 3. As is shown in FIG. 2, the mast 36 extends uprightly from a mount 38 that can be part of a base 40 attached to a wheeled trailer or other transport vehicle 42, such as a trailer/transport vehicle 42 equipped with a source of electrical power. Such a source of electrical power can be in the form of electrical charge storage devices, such as one or more batteries or the like, can be in the form of a generator, such as an internal combustion engine powered generator, or can be configured in another manner, such as with solar cells or the like, to provide electrical power to charge the batteries, and ultimately supply electrical power to each luminaire 11 or light 22.

A mount 38 and/or base 40 can pivotally support the mast 36 of the tower 20 in a manner that allows the tower 20 to be movable between a generally upright orientation, such as the upright operating position shown in FIG. 2, and a transport or storage orientation, such as the generally horizontal storage/transport position shown in FIG. 3. To provide increased stability when the mast 36 of the tower 20 is disposed in its upright operating position, one or more removable outriggers 44 can be extended from the base 40 or another portion of the vehicle 42. Tongue 46 is also configurable, such as in the manner depicted in FIG. 2, to further help increase stability. As is shown in FIG. 3, mast 36 can be received in a cradle 45 spaced from a pivot 47 of mount 38 when disposed in the generally horizontal storage position with the cradle 45 carried by part of vehicle 42, such as a housing 49 that encloses the onboard source of electrical power. A bracket 48 attaches the luminaires 11 or lights 22 to a crossbar 50 of a carriage 52 disposed at or adjacent the upper or free end of the mast 36 of the tower 20. Bracket 48 can be constructed and arranged to pivotally attach to opposite sides of the fixture 26 or casing 29 of each luminaire 11 or light 22 in a manner that can permit the angle of the luminaire 11 or light 22 to be adjusted, as well as to allow pivoting of each luminaire 11 or light 22 to a storage position.

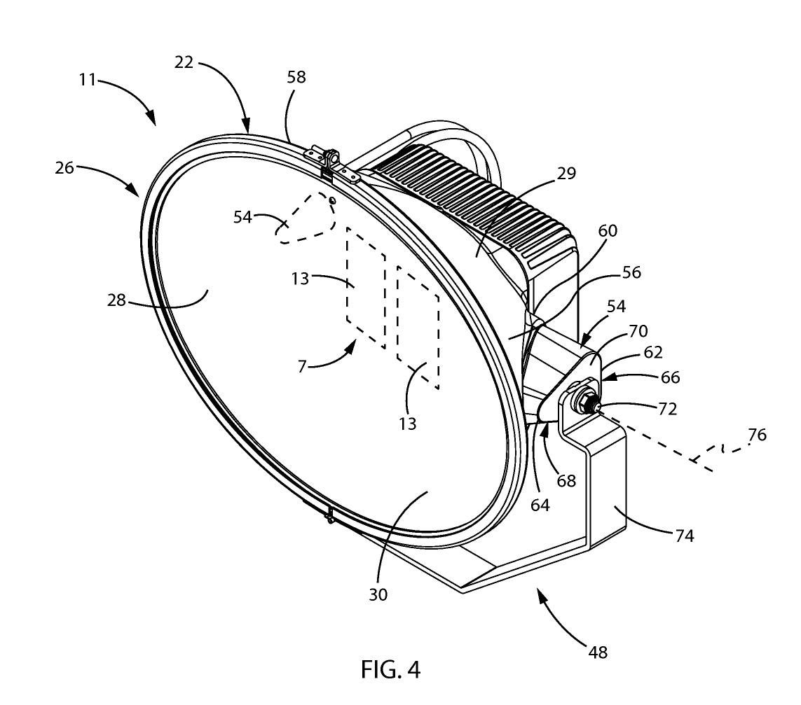

Referring now to FIG. 4, in this embodiment, the luminaire 11 or light 22 includes a light fixture casing 29 that defines a generally oval shape that can include or integrally form or provide a reflector 30 that can also be generally oval in shape. A pair of light fixture mounts 54 extend outwardly from opposite sides 56, 58 of the casing 29. Each mount 54 is shown arranged toward a casing back wall 60 and is shown as an ear mount with back and front edges 62, 64 defined at back and front portions 66, 68, respectively. The back portion 66 tapers toward the front portion 68 so that the back and front portions 66, 68 provide a generally flat face 70 with a triangular perimeter shape. A stud 72 extends from each of the mounts 54 to connect the light 22 to a corresponding arm 74 of the bracket 48. A pivot axis 76, about which the light 22 can pivot, is defined through the studs 72. The studs and pivot axis 72, 76 are arranged at intermediate portions of the mount 54 and may be closer to the back edges 62 than the front edges 64 for minimizing forces required to resist offset center of gravity torque components. Pivoting the lights 22 about the pivot axes 76 allows for directing light emitted from the luminaire 11 or light 22 toward a desired area to be illuminated.

The emitted light is produced by a light source that preferably is in the form of an LED lighting system 7, shown in FIG. 4 as having two LED modules 13 mounted to part of the casing 29 within the light fixture 26 and covered by lens 28. The LED lighting system 7 can be in the form of a module, board or the like that carries the LED modules 13 with the LED lighting system 7 substantially weather tightly sealed by the lens 28 within the casing 29 such that the LED lighting system 7 is housed within the light fixture 26.

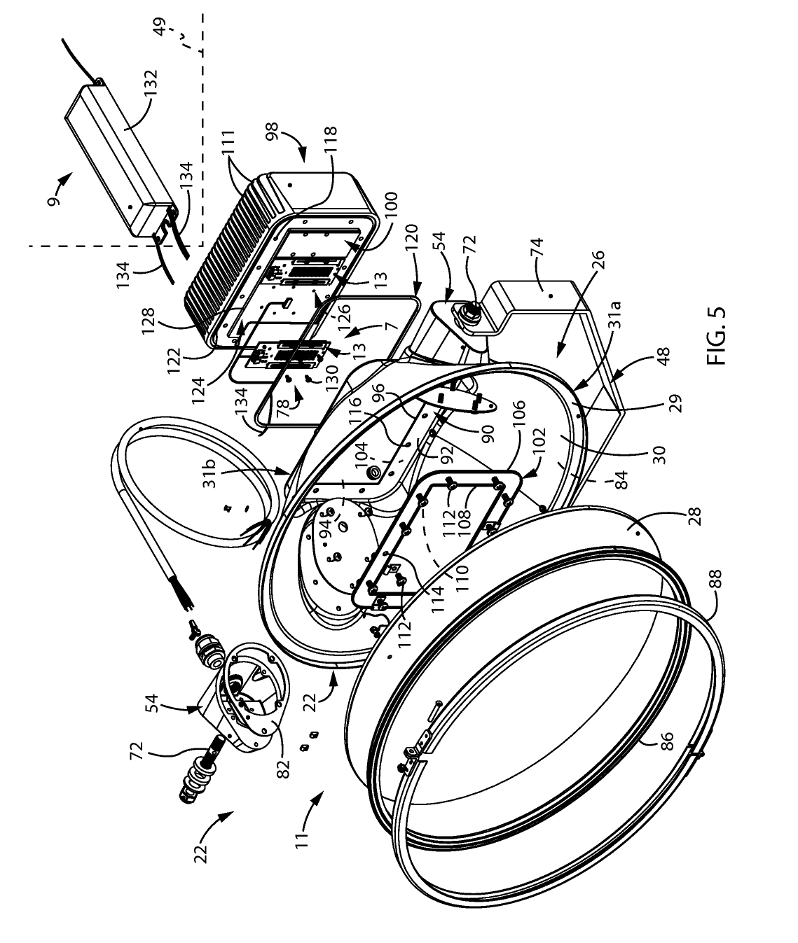

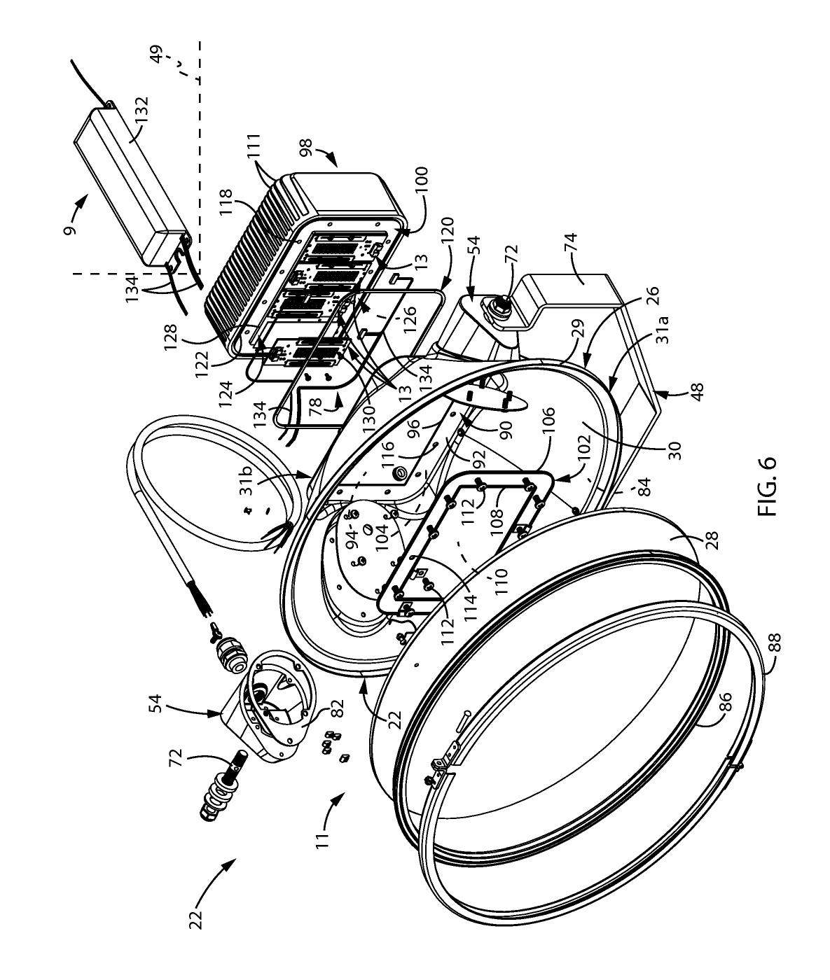

Referring now to FIGS. 5 and 6, gaskets 82 are arranged for providing a substantially weather tight and/or water tight seal between the mounts 54 and the light fixture casing 29. Where the reflector 30 is integrally formed of or with the casing 29 such as is shown in FIGS. 5 and 6, the gaskets 82 can be arranged for providing a substantially weather tight and/or water tight seal between the mounts 54 and the reflector 30. Toward an opening 84 at a forward facing end 31a of the reflector 30 from which light beams are emitted from the light 22 during operation, the lens 28 is sealed against the casing 29 by way of a rubber ring as a gasket 86 is compressed against an outer perimeter of the lens 28 with a ring clamp 88. A rearward facing end 31b of the reflector 30 includes a reflector back wall 90 that defines a recessed shelf 92 with an opening 94 defined inwardly of an inner perimeter 96.

The luminaire 11 or light 22 preferably also includes a heatsink 98 that conducts heat away from each one of the LED modules 13 of an LED lighting system 7 received within the light fixture casing 29. The LED lighting system 7 is in contact with the heatsink 98 causing heat generated by the LED modules 13 of the LED lighting system 7 during operation to be transferred via thermal conduction away from the LED lighting system 7 where the heat is dissipated to the ambient air outside of the luminaire 11 or light 22. The LED lighting system 7 preferably is mounted to the heatsink 98 such that the LED lighting system 7 is in direct contact with the heatsink 98 conducting heat generated by the LED modules 13 of the LED lighting system 7 to ambient. A thermally conductive paste, such as ARTIC SILVER or the like, can be disposed between the LED lighting system 7 and the heatsink 98. If desired, each one of the LED modules 13 of the LED lighting system 7 can be in direct contact with the heatsink 98, can have thermally conductive paste between each LED module 13 and the heatsink 98, and can be fixed directly to the heatsink 98 if desired. The heatsink 98 has a plurality of pairs of spaced apart and outwardly extending heat transfer fins 111 that extend outwardly into the ambient air exteriorly surrounding the fixture 26 of the luminaire 11 or light 22.

The LED lighting system 7 can be pre-assembled to the heatsink 98 by being fixed to the heatsink 98 forming a pre-assembled module that can be plugged into an opening in the light fixture casing 29 during assembly of the luminaire 11 or light 22. The heatsink 98 is formed, e.g., cast, of a metal that preferably is aluminum or an aluminum alloy helping to more efficiently conduct and dissipate heat produced by the LED modules 13 of LED lighting system 7 when emitting light during luminaire or light operation.

A wall of the heatsink 98, shown as a front wall 100, covers the back wall opening 94 of the casing 29 and/or reflector 30. Fins 111 of the heatsink 98 extend in an opposite direction relative to the front wall 100, extending outwardly with respect to the reflector back wall 90. The heatsink front wall 100 faces toward the opening 84 of the reflector 30 and an outwardly facing surface of the reflector back wall 90. A backing plate 102 is arranged within the opening 94 and sits within a recess 104 of the recessed shelf 92. The backing plate 102 defines outer and inner perimeters 106, 108 that are generally rectangular in shape. An opening 110 is defined within the inner perimeter 108 of the backing plate 102. The opening 110 is aligned with the opening 94 of the reflector back wall 90. Multiple fasteners 112 are spaced from each other and are arranged outwardly of the back wall and backing plate openings 94, 110. The fasteners 112 extend through bores 114, 116 of the backing plate 102 and reflector back wall 90 and are threadably received in bores 118 of the heatsink front wall 100, so that the reflector back wall 90 is sandwiched between the backing plate 102 and the heatsink 98. A gasket 120 provides a seal between the back wall 90 and the heatsink 98 to establish a watertight seal toward the rearward facing end 31b of the reflector 30. The gasket 120 is arranged outwardly of the back wall and backing plate openings 94, 110 and the fasteners 112. The heatsink front wall 100 may include a groove 122 that receives the gasket 120 for locating the gasket 120 in an outboard or outwardly disposed position with respect to the fasteners 112. Water drain valves (not shown) may be arranged at the light 22 to allow water to drain out of the reflector 30.

Still referring to FIGS. 5 and 6, a platform 124 extends from a middle portion 126 of the heat sink front wall 100 and has an outer perimeter 128 that corresponds to the inner perimeter 96 of the reflector back wall 90 to allow the platform 124 to nest within the inner perimeter 96. The outer perimeter 128 of platform 124 may engage the inner perimeter 96 of the reflector back wall 90 and/or inner perimeter 108 of the backing plate 102 to allow thermal transfer between the heatsink 98 and the reflector 30, in addition to respective interfacing surfaces of the heatsink front wall 100 and the reflector back wall 90. This can and preferably does help facilitate dissipation of heat from the LED modules 13 that are secured to the platform 124 by fasteners 130. FIG. 5 shows an embodiment in which two LED modules 13 are secured to the platform 124 and FIG. 6 shows an embodiment in which four LED modules 13 are secured to the platform 124, although it is understood that other numbers of LED modules may be provided within the LED system 7. Regardless of how many LED modules 13 are provided within the LED system 7, each of the LED modules 13 receives power from a respective power source of the control system 9, shown as an LED driver 132 by way of conductors 10a. Each of the conductors 10a may include multiple wires or other conductors for transmitting electrical power and signals. The LED driver(s) 132 may be arranged at a location that is remote from the reflector 30, shown in the embodiments as arranged within the housing 49, although it is understood that the LED driver(s) 132 may be arranged at another location within the light tower 20.

Referring now to FIGS. 7-10, the thermally responsive LED lighting control system 5 has a temperature control system 136 that includes a heatsink 98 that removes heat from the LED modules 13 during lighting system operation and a temperature controlling arrangement 138 that is defined at least in part by the temperature responsive lighting power control system 9. In one embodiment, the temperature controlling arrangement 138 cooperates with a controller 140 of the control system 9 to provide power to or otherwise control at least one LED driver 132 and the corresponding LED modules 13. The controller 140 may include a processor, e.g. microcontroller, an industrial computer or, e.g., a programmable logic controller (PLC), along with corresponding software, firmware, and/or suitable onboard memory and/or data storage for storing such software, firmware, detected temperature data and the like including interconnecting conductors for power and signal transmission to the LED driver(s) 132 for maintaining the temperature of the LED modules 13 below a maximum allowable temperature, as explained in greater detail elsewhere herein.

Still referring to FIGS. 7-10, each of the LED modules 13 includes multiple LED chip assemblies 15 arranged to project light out of the light fixture opening 84 and a connector 10 and conductors 10a electrically connecting the LED chip assemblies 15 to the LED driver(s) 132 of the control system 9. The heat detection zones 17 are provided at locations for measuring temperature of the LED modules 13 by way of a temperature sensor 18, such as at the heat detection zones 17 defined within heated zones 19 upon the LED modules 13 and/or interface of the LED modules 13 and wall 100 of heatsink 98. In another embodiment, the detection zones 17 are provided at locations for indirectly measuring temperature of the LED modules 13. In such embodiments configured for indirectly measuring temperature, the detection zones 17 are spaced from the LED modules 13, but within a path of thermal conductivity with the heated zone 19, for example, upon the wall 100 of this heatsink 98, but spaced from the LED modules 13. The heated zones 19 of the LED modules 13 are defined at the heatsink 98 at locations that correspond to the respective matrices of LED chip assemblies 15 of the LED modules 13. The heated zones 19 define localized areas of relatively high heat transmission from the LED modules 13 to the heatsink 98. The LED modules 13 are arranged with respect to each other upon the heatsink 98 so that the heated zones 19 are spaced from each other, shown as adjacent heated zones 19 being in an alternating relationship relative to upper and lower portions 148, 150 of the wall 100 of the heatsink 98.

Still referring to FIGS. 7-10, in at least one embodiment, the temperature control system 136 is configured to ensure that a minimum acceptable lumen or lux lighting output value is provided at all times by the LED system 7 while controlling electrical power supplied to at least one of the LED modules 13 to thermally protect the LED modules 13. The temperature control system 136 preferably is configured to reduce the amount of electrical power supplied to at least one of the LED modules 13 of the LED lighting system 7 of the luminaire 11 or light 22 when a temperature in a detection zone 17 exceeds a preset threshold temperature by attenuating the voltage and/or current of the electrical power supplied to at least one of the LED modules 13. Attenuation of the electrical power supplied to at least one of the LED modules 13 of the LED lighting system 7 can be and preferably is increased proportional to the number of degrees the detection temperature is over or greater than the predetermined threshold temperature. In one temperature control system control method, the voltage and/or current of the electrical power supplied to at least one of the LED modules 13 of the LED system 7 is attenuated by decreasing the magnitude of the voltage and/or current linearly as the detected temperature exceeds the threshold temperature. In another temperature control system control method, the voltage and/or current of the electrical power supplied to at least one of the LED modules 13 of the LED system 7 is attenuated by decreasing the magnitude of the voltage and/or current stepwise either linearly or in proportion relative to the amount that the detected temperature exceeds the threshold temperature.

As discussed in more detail below, in at least one of the aforementioned control methods the temperature control system 136 is configured to carry out, the LED system 7 has at least a plurality of LED modules 13 arranged side-by-side adjacent one another with at least one of the LED modules 13 being a regulated module that is regulated by attenuating electrical power supplied thereto when the detected temperature exceeds a predetermined threshold temperature with at least one of the other LED modules 13 being unregulated such that electrical power supplied thereto is not regulated such that the electrical power supplied to each unregulated LED module 13 remains substantially constant. In at least one of the aforementioned control methods that the temperature control system 136 is configured to carry out, the LED system 7 has at least a plurality of pairs, i.e., at least three, LED modules 13 arranged side-by-side adjacent one another with at least one of the LED modules 13 being a regulated LED module that is regulated by attenuating electrical power supplied thereto when the detected temperature exceeds a predetermined threshold temperature with at least a plurality of the other LED modules 13 being unregulated LED modules such that electrical power supplied thereto is not regulated such that the electrical power supplied to each unregulated LED module 13 remains substantially constant.

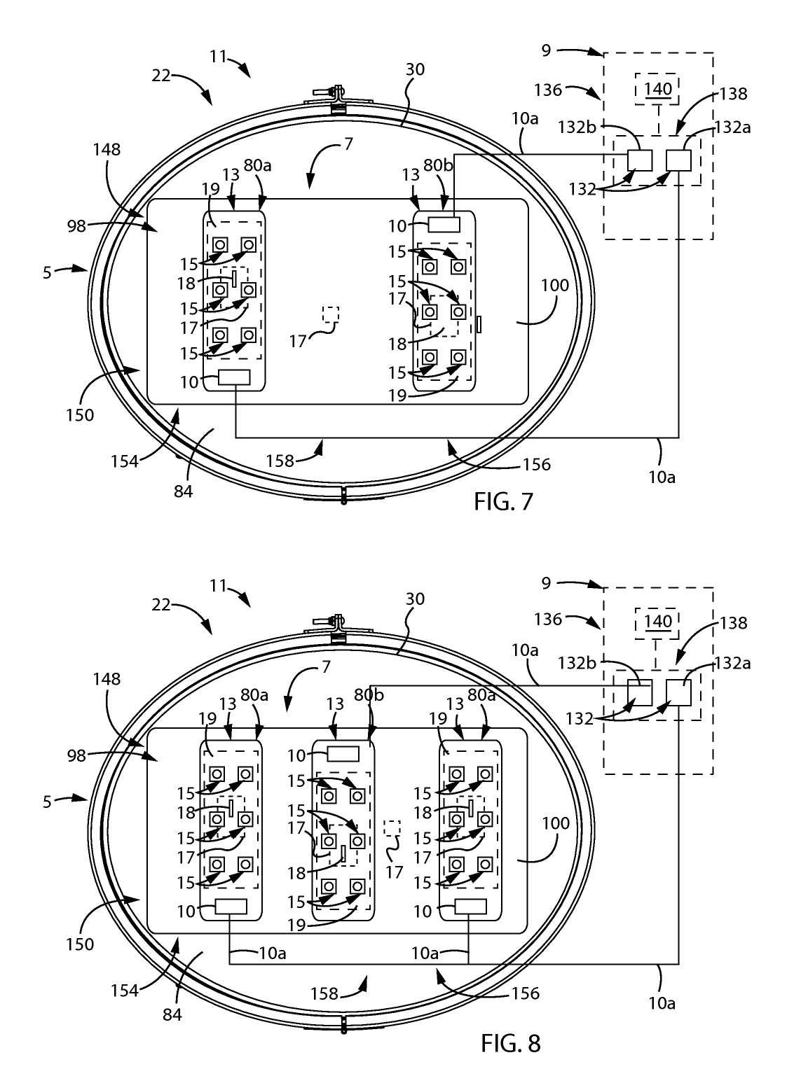

In at least one such control method that the temperature control system 136 is configured to carry out, the LED system 7 has at least a plurality of pairs, i.e., at least three, LED modules 13 arranged side-by-side adjacent one another with at least one of the LED modules 13 disposed in between a pair of the LED modules 13 being a regulated module and the LED module 13 on either side of the regulated module being an unregulated module. In one such control method that the temperature control system 136 is configured to carry out, the LED system 7 has three LED modules 13 arranged side-by-side adjacent one another in the manner shown in FIG. 8 with the outer LED modules 13 being unregulated modules and the inner LED module 13 disposed between the outer LED modules being a regulated module.

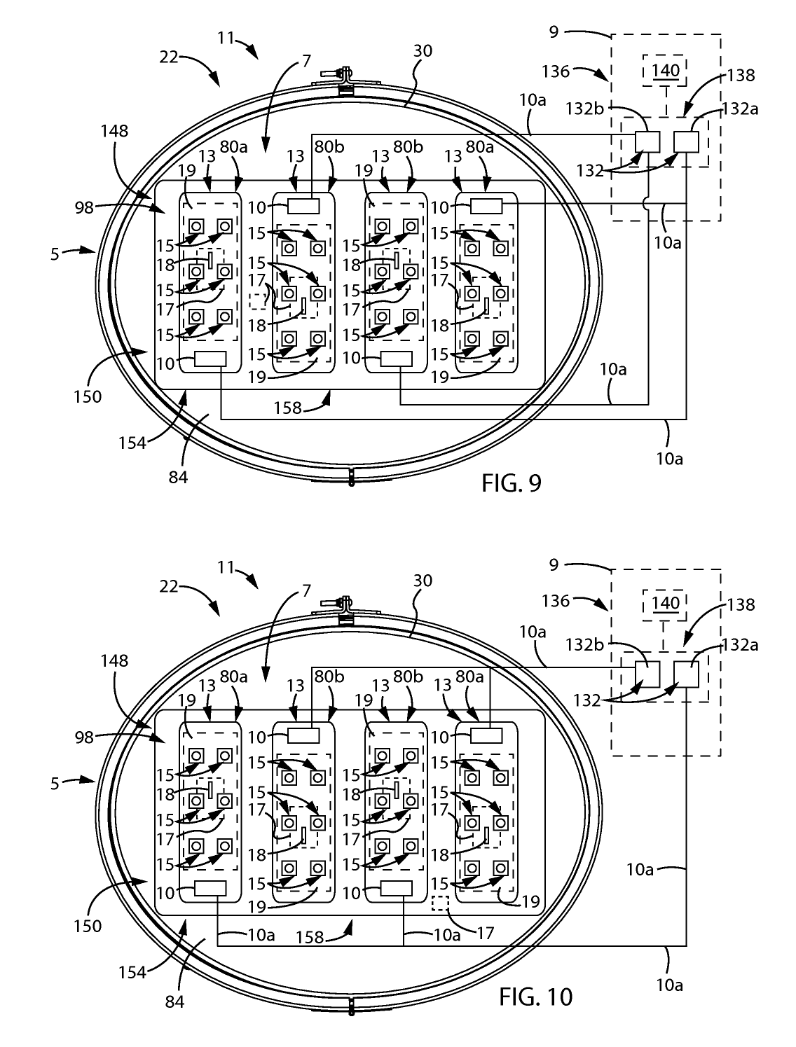

In at least one other such control method that the temperature control system 136 is configured to carry out, the LED system 7 has four LED modules 13 arranged side-by-side adjacent one another such as in the manner shown in FIGS. 9 and/or 10 with at least one of the inner LED modules 13 disposed in between a pair of the LED modules being a regulated module and the LED module on either side of the inner regulated module being an unregulated module. In one such LED lighting system 7 equipped with four LED modules 13 arranged side-by-side adjacent one another in the manner shown in FIG. 9 and/or FIG. 10 has a pair of outer LED modules 13 between which is disposed a pair of inner LED modules 13 with the inner LED modules 13 being regulated LED modules and the outer LED modules being unregulated LED modules. In another such LED lighting system 7 equipped with four LED modules 13 arranged side-by-side adjacent one another in the manner shown in FIG. 9 and/or FIG. 10 has alternating regulated and unregulated LED modules such that one of the first and third LED modules 13 and the second and fourth LED modules 13 are regulated LED modules and the other one of the first and third LED modules 13 and the second and fourth LED modules 13 are unregulated LED modules.

Referring now to FIG. 7, in this embodiment, the LED system 7 includes two LED modules 13. A minimum lighting value such as a minimum acceptable lighting value can be provided by a single one of LED modules 13, represented as an unregulated LED module 80a. During use of the thermally responsive LED lighting control system 5, the unregulated LED module 80a may receive electrical power from an unregulated LED driver 132a of the control system 9 for constantly illuminating the unregulated LED module 80a. Heat is constantly produced in the heated zone 19 of the unregulated LED module 80a and is constantly drawn into the heatsink 98 at the heated zone 19 and dissipated through the heatsink 98 for thermal transfer to the surrounding air and cooling of the LED modules 13. A regulated LED module 80b may receive electrical power from a regulated LED driver 132b of the control system 9 for variably illuminating the regulated LED module 80b based on a detected temperature. The temperature sensor 18 may be arranged at the regulated LED module 80b and operably connected to the temperature control system 136 for detecting a temperature that is evaluated by the temperature control system 136 for regulating the regulated LED module 80b. The temperature sensor 18 may be arranged at a different location on the regulated LED module 80b or other location(s), such as at the unregulated LED module 80a, on the heatsink 98, reflector 30, or other location within the light 22. The unregulated and regulated LED modules 80a, 80b are shown spaced from each other by a distance that is at least as wide as the LED modules 13, with the unregulated module 80a arranged toward a first or left side 154 of the heatsink 98 and the regulated module 80b arranged toward a second or right side 156 and within an intermediate portion 158 of the heatsink 98. In one embodiment, the unregulated module 80a is arranged within the intermediate portion 158 and the regulated module 80b is arranged toward the first or second side 154, 156 of the heatsink 98. The unregulated and regulated LED modules 80a, 80b may be arranged both within the intermediate portion 158 of the heatsink 98, or both outside of the intermediate portion 158 and toward the first or second side 154, 156 of the heatsink 98.

Referring now to FIG. 8, this embodiment differs from that of FIG. 7 in that LED system 7 includes three LED modules 13. A minimum lighting value such as a minimum acceptable lighting value is provided by two unregulated LED modules 80a arranged toward the first and second sides 154, 156 of the heatsink 98. The unregulated LED modules 80a are powered by an unregulated LED driver132a of the control system 9 for constantly illuminating the unregulated LED modules 80a. A single regulated LED module 80b receives electrical power from a regulated LED driver 132b of the control system 9 for variably illuminating the regulated LED module 80b based on a detected temperature. The regulated LED module 80b is arranged between the unregulated LED modules 80a. The heated zones 19 of the unregulated LED modules 80a are arranged at the upper portion 148 of the wall 100 of the heatsink 98. The heated zone 19 of the regulated LED module 80b is arranged toward the lower portion 150 of the wall 100 of the heatsink 98. In one embodiment, the heated zones 19 at the unregulated and regulated LED modules 80a, 80b are arranged at the lower and upper portions 150, 148 of the wall 100 of the heatsink 98, respectively.

Referring now to FIG. 9, this embodiment differs from those of FIGS. 7 and 8 in that the LED system 7 includes four LED modules 13. A minimum lighting value such as a minimum acceptable lighting value is provided by two unregulated LED modules 80a arranged toward the first and second sides 154, 156 of the heatsink 98. The unregulated LED modules 80a are powered by an unregulated LED driver132a of the control system 9 for constantly illuminating the unregulated LED modules 80a. Two regulated LED modules 80b receive electrical power from a regulated LED driver 132b of the control system 9 for variably illuminating the regulated LED modules 80b based on a detected temperature. The regulated LED modules 80b are arranged between the unregulated LED modules 80a. The heated zone 19 of the unregulated LED module 80a toward the first side 154 of the heatsink 98 is arranged at the upper portion 148 of the wall 100 of the heatsink 98. The heated zone 19 of the unregulated LED module 80a toward the second side 156 of the heatsink 98 is arranged at the lower portion 150 of the wall 100 the heatsink 98. The heated zones 19 of the unregulated LED modules 80a may be arranged in the opposite orientation as that shown in FIG. 9. The heated zone 19 of the regulated LED module 80b nearest the first side 154 of the heatsink 98 is arranged at the lower portion 150 of the wall 100 of the heatsink 98. The heated zone 19 of the regulated LED module 80b nearest the second side 156 of the heatsink 98 is arranged at the upper portion 148 of the wall 100 of the heatsink 98. The heated zones 19 of the regulated LED modules 80b may be arranged in the opposite orientation as that shown in FIG. 9.

Referring now to FIG. 10, this embodiment differs from those of FIGS. 7 and 8 in that the LED system 7 includes four LED modules 80. The LED system 7 of FIG. 10 is similar to that shown in FIG. 9 in that a minimum lighting value such as a minimum acceptable lighting value is provided by two unregulated LED modules 80a. The unregulated and regulated LED modules 80a, 80b are arranged in an alternating series across the heatsink 98, as are the respective heated zones 19. In this arrangement, an unregulated LED module 80a is provided at one of the first and second sides 154, 156 of the heatsink 98. A regulated LED module 80b is provided at the other one of the first and second sides 154, 156 of the heatsink 98. Each of an unregulated and a regulated LED module 80a, 80b is arranged in the intermediate portion 158 of the heatsink 98.

Referring again to FIGS. 7-10, in one embodiment, the heatsink 98 defines a cooling capacity value that is greater than a heat-generating capability of the unregulated LED modules 80a, but may be less than a summed heat-generating capability of the unregulated LED modules 80a combined with the heat-generating capability of the regulated LED modules 80b. In this way, the heatsink 98 is always able to provide sufficient cooling for the LED system 7, when the unregulated LED modules 80a are continuously operating. Operation of the regulated LED modules 80b is regulated to energize the regulated LED modules 80b to supplement illumination when the system temperature is below the maximum safe operating limit of the LED modules 13 and to reduce power to the regulated LED modules 80b when the system temperature reaches a threshold level while maintaining continuous operation of the unregulated LED modules 80a. This allows for uninterrupted illumination from the LED system 7 while regulating temperature of the light source 70.

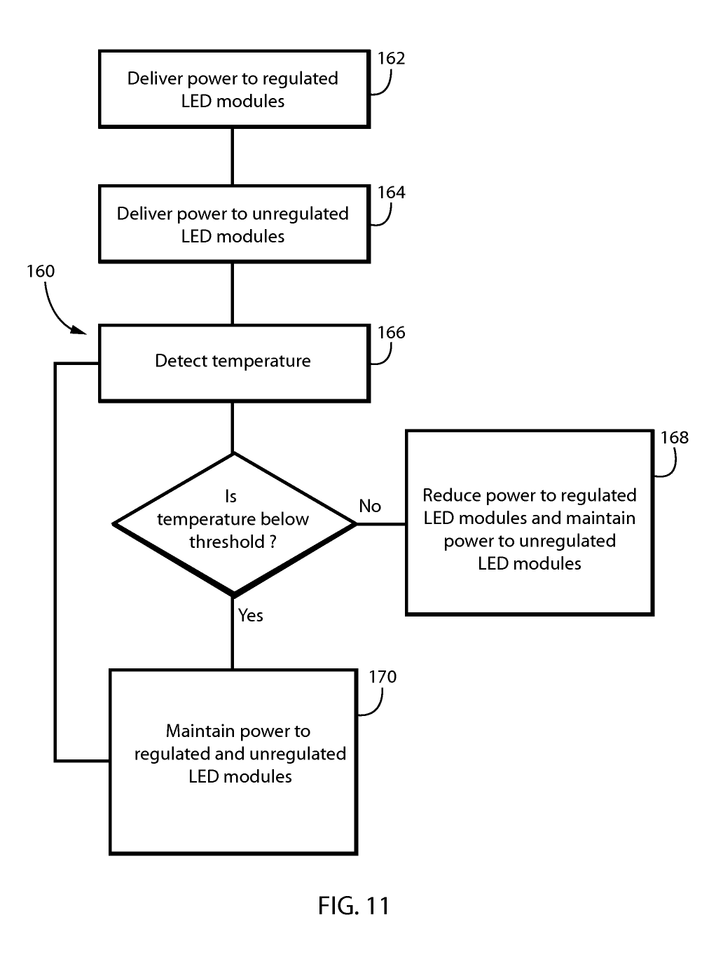

Referring now to FIG. 11 and with further reference to FIGS. 1-2 and 7-10, an exemplary method 160 of providing a high intensity lighting system controlled by a thermally responsive LED lighting control system 5 constructed in accordance with the present invention is depicted. As represented at block 162, electrical power is delivered to at least one regulated LED 80b module so as to illuminate the LEDs of the regulated LED 80b module(s). This may be done by way of a regulated LED driver 132b. As represented at block 164, electrical power is delivered to at least one unregulated LED 80a module so as to illuminate the LEDs 15b (FIG. 1) of the unregulated LED 80a module(s). This may be done by way of an unregulated LED driver 132a. As represented at block 166, a temperature within the light 22 is detected. This may include using one or more temperature sensors 18 to detect a temperature at a heat detection zone 17 which may be at a heated zone 19 of one or more of the LED modules 13 or a different location within the lamp 11, such as at the heatsink 98, reflector 30, or other portion of the lamp 11. As represented at block 168, electrical power delivered to the regulated LED module 80b is reduced based at least in part on the detected temperature while maintaining an amount of electrical power delivered to the unregulated LED module 80a. This may be done when the detected temperature reaches an upper threshold level, such as a maximum allowable use temperature for the LED modules 13 or a sub-threshold value such as temperature below but approaching the maximum allowable use temperature. The maximum allowable use temperature for the LED modules 13 and the upper threshold level value may be defined as a temperature above which solder joints or other components of the LED modules 13 become compromised, such as about 85° C., at which the control system 9 reduces power delivery to the regulated LED module(s) 80b. A sub-threshold value may be used by the control system 9 to reduce power delivery to the regulated LED module(s) 80b at a detected temperature value that is less than the maximum allowable use temperature for the LED module 13. For example, if a maximum allowable use temperature for the LED modules 13 is about 85° C., then the control system 9 may use a sub-threshold value of about 83° C. or about 80° C. to reduce power delivery to the regulated LED module(s) 80b to attenuate transfer of additional heat from the regulated LED modules 80b below the temperature at which the integrity of the LED modules 13 may become compromised.

The upper threshold level may also correspond to a temperature or rate of temperature change at which the heatsink 98 becomes heat soaked and can no longer shed heat faster than the heatsink 98 is absorbing heat. The reduction may be an on/off-type modulation or a throttling-type or dimming-type reduction in the amount of electrical power delivered to the regulated LED module(s) 80b. The reduction may continue until the detected temperature drops below the upper threshold level or the reduction may continue until the detected temperature reaches a lower threshold level, at which point the regulated LED module(s) 80b are reenergized. The lower threshold level may be a temperature at or below which the heatsink 98 is able to suitably shed heat while maintaining the LED modules 13 at or below their maximum heat generating level. This defines a modulated cooling range between a thermal shutoff value at a value of an upper threshold level and a thermal-safe repower value. The modulated cooling range may be defined between a thermal shut off value and a thermal-safe repower value of between about 85° C. and 70° C. The upper threshold level and safe repower values may be defined by an upper threshold level value of 85° C. and a thermal-safe repower value of 80° C., an upper threshold level value of 83° C. and a thermal-safe repower value of 78° C., an upper threshold level value of 80° C. and a thermal-safe repower value of 75° C., or other ranges defined between combinations of upper threshold level and thermal-safe repower values of between about 85° C. and about 70° C. Block 170 represents the detected temperature being at or below the lower threshold level so that power is delivered to both the unregulated and regulated LED modules 80a, 80b. Temperatures are subsequently and repeatedly detected, as are the above evaluations and controlling or regulating of the regulated LED module(s) 80b during use of the light tower 20.

There are many possible variations contemplated regarding the construction of LED system 7 and the temperature control system 136. For example, different numbers of unregulated and regulated LED modules 80a, 80b may be provided, such as more regulated LED modules 80b and unregulated LED modules 80a within a LED system 7. The LED modules 13 may be arranged in a generally sideways or horizontal-type orientation, instead of the generally upright or vertical type orientation as shown. The unregulated LED modules 80a may be modulated by the control system 9 based on detected system temperature, but to a lesser extent than the regulated LED modules 80b modulated to ensure output or emission of an acceptable minimum lumen or lux lighting value as a result of operation of the thermally responsive LED lighting control system 5. The lamp 11 may have a single LED module 13 that illuminates for providing light from the lamp 11. The sole LED module 13 is modulated by the control system 9 for maintaining the LED module 13 at or below the threshold temperature value by controlling the amount of electrical power delivered to the LED module 13, which may include modulating power delivered to all of the LEDs 15b or a subset of fewer than all of the LEDs 15b based on detected temperature within the lamp 11, while maintaining at least some illumination from the lamp 11.

In one preferred method of operating a lighting system such as a high output or high intensity lighting system shown in one or more of FIGS. 2, 4-10 controlled by a thermally responsive LED lighting control system 5 where the high output or high intensity lighting system has at least one luminaire 11 with a plurality of light emitting LED modules 13 to maintain a desired minimum light output level from the lamp 11 under high temperature operating conditions, electrical power is delivered to the LED modules 13 causing light to be outputted from the lamp 11 at a first light output level, a temperature of the lamp 11 is detected, and the delivery of the electrical power to the LED modules 13 is controlled when the temperature exceeds a threshold supplying sufficient electrical power to maintain at least the minimum output level while allowing cooling to occur to reduce lamp temperature below the threshold. Where a high intensity lighting system controlled by a thermally responsive LED lighting control system 5 of the present invention has a plurality of such luminaires 11 each equipped with at least a plurality of LED modules 13, electrical power delivery to each lamp 11 preferably is independent controlled to regulate the temperature of each lamp 11 independently of every other lamp 11.

In one implementation of such a control method carried out when the threshold temperature is exceeded, electrical power delivered to at least one of the LED modules 13 of the lamp 11 is reduced while electrical power delivered to at least one other LED module 13 of the lamp 11 is not reduced such that the reduction of electrical power to the at least one of the LED modules 13 of the lamp 11 enables cooling of one or more LED modules 13 of the lamp 11 to occur reducing the lamp light output level below the maximum or first light output level while maintaining the lamp light output at or above the desired minimum light output level. In another control method implementation, delivery of electrical power to at least one of the LED modules 13 of the lamp 11 is ceased while delivery of electrical power to at least one other LED module 13 of the lamp 11 is maintained outputting light from the at least one other LED module 13 of the lamp 11 sufficient for the lamp light output level to meet or exceed the desired minimum light output level.

In one preferred control method implementation, the lamp 11 has a plurality of pairs of LED modules 13, i.e., at least three LED modules 13, with delivery of electrical power controlled when the threshold temperature is exceed by reducing electrical power to one of the plurality of pairs of LED modules 13 while not reducing electrical power to a plurality of the plurality of pairs of LED modules 13. In one such control method implementation, delivery of electrical power is controlled to maintain delivery to a plurality of the plurality of pairs of LED modules 13 while stopping delivery of electrical power to at least one of the plurality of pairs of LED modules 13.

When electrical power is delivered at the same time to each one of the plurality of LED modules 13 of a lamp 11, such as during lamp startup and when the detected temperature is below the threshold temperature, light is outputted at the same time from all of the LED modules 13 of the lamp 11 causing the lamp 11 to output light at a first lumen output level that is greater than the minimum light output level, i.e., minimum lumen output level. When the same amount or magnitude of electrical power is delivered to each one of the plurality of LED modules 13 of a lamp 11 at the same time, such as during lamp startup and when the detected temperature is below the threshold temperature, a maximum lumen output level of light is outputted from each LED module 13 of the lamp 11 at the same time causing the lamp 11 to output light at a maximum lumen output level that is greater than the minimum light output level, i.e., minimum lumen output level.

A controller 140, such as a control circuit equipped with a processor, e.g., microprocessor, microcontroller, etc., is used to monitor lamp temperature preferably by substantially continuously detecting a temperature of the lamp 11 during lamp operation within a zone of the lamp 11 that encompasses at least one of the LED modules 13 of the lamp 11 and which can encompass a plurality of the LED modules 13 of the lamp 11 thereby enabling LED module temperature(s) to be monitored. Such a controller 140 can be disposed onboard the lamp 11 or located remote from the lamp 11 but electrically connected thereto. Where one or more of the LED modules 13 of the lamp 11 are equipped with an onboard temperature sensor 18, e.g., thermocouple, temperature detection can be accomplished by the controller monitoring the temperature of at least one of the LED modules 13 by detecting the temperature of the onboard temperature sensor 18 of at least one of the LED modules 13.

The controller 140 can be configured to detect lamp temperature and control delivery of electrical power to the LED modules 13 of the lamp 11 when the threshold temperature is exceeded to reduce electrical power delivered to one or more LED modules 13 of the lamp sufficient to reduce the detected temperature without reducing lamp light output below a desired minimum light output level. In one preferred method implementation and embodiment, electrical power to one or more of the LED modules 13 of the lamp 11 is reduced or ceased until the detected temperature drops below the threshold while continuing to deliver electrical power to one or more of the LED modules 13 of the lamp 11 sufficient to output a light level of at least 40% of the total rated light output level of all of the LED lamps or modules 13 of the lamp 11 when all LED modules 13 are output light at the same time. Where a lamp 11 has three LED modules 13 each rated to output at least 4000 lumens for a total rated light output level of 12,000 lumens, delivery of electrical power to at least one of the LED modules 13 is controlled when threshold temperature is exceeded to reduce the lamp light output level below the total rated light output level of 12,000 lumens but maintain a lamp light output level that is at least 4800 lumens that is at least 40% of the total rated light output level of the lamp when all three LED modules 13 are operating.

In another preferred method implementation and embodiment, electrical power to one or more of the LED modules 13 of the lamp 11 is reduced or ceased until the detected temperature drops below the threshold while continuing to deliver electrical power to one or more of the LED modules 13 of the lamp 11 sufficient to output a light level of at least 50% of the total rated light output level of all of the LED lamps or modules 13 of the lamp 11 when all LED modules 13 are output light at the same time. Where a lamp 11 has three LED modules 13 each rated to output at least 4000 lumens for a total rated light output level of 12,000 lumens, delivery of electrical power to at least one of the LED modules 13 is controlled when threshold temperature is exceeded to reduce the lamp light output level below the total rated light output level of 12,000 lumens but maintain a lamp light output level that is at least 6000 lumens that is at least 50% of the total rated light output level of the lamp 11 when all three LED modules 13 are operating.

Various alternatives are contemplated as being within the scope of the following claims particularly pointing out and distinctly claiming the subject matter regarded as the invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

What is claimed is:

1. A lighting system for providing high intensity lighting, the lighting system comprising:
a lamp from which light is directed toward a location to be illuminated;
an LED system having multiple LED modules mounted inside of the lamp, each of the multiple LED modules including LEDs arranged to project light out of the lamp, the LED system defining a heat detection zone at which heat is detected to define a detected temperature inside of the lamp; and
a control system connected to the LED system for controlling an amount of electrical power delivered to at least one of the multiple LED modules to regulate temperature of the LED system based at least in part on the detected temperature inside of the lamp.

2. The lighting system of claim 1 wherein the heat detection zone is defined as including at least one of the multiple LED modules.

3. The lighting system of claim 2 wherein the heat detection zone is defined within a heated zone of the at least one of the multiple LED modules receiving heat energy from the LEDs of the respective at least one of the multiple LED modules.

3. The lighting system of claim 2 wherein a temperature sensor is mounted at the heat detection zone of the at least one of the multiple LED modules.

4. The lighting system of claim 3 wherein the temperature sensor is defined by a thermocouple mounted to the at least one of the multiple LED modules.

5. The lighting system of claim 1 wherein a first one of the multiple LED modules is controlled based on the detected temperature inside of the lamp and a second one of the multiple LED modules is not controlled based on the detected temperature inside of the lamp.

6. The lighting system of claim 1 wherein the heat detection zone is defined as including a first LED module of the multiple LED modules within a heated zone of the first LED module receiving heat energy from the LEDs of the first LED module wherein the detected temperature inside of the lamp corresponds to a detected temperature of the first LED module and wherein the first LED module is controlled based on the detected temperature of the first LED module ,and wherein a second LED module of the multiple LED modules is not controlled based on the detected temperature of the first LED module.

7. The lighting system of claim 1 wherein the multiple LED modules define a pair of unregulated LED modules that are not controlled based on the detected temperature inside of the lamp.

8. The lighting system of claim 7 wherein the control system modulates at least one regulated LED module by controlling the amount of electrical power delivered to the at least one regulated LED module, and wherein the at least one regulated LED module is arranged between the pair of unregulated LED modules.

9. The lighting system of claim 1 wherein the multiple LED modules define a pair of unregulated LED modules that are not controlled based on the detected temperature inside of the lamp a pair of regulated LED modules that is controlled based on the detected temperature inside of the lamp.

10. The lighting system of claim 9 wherein the pair of regulated LED modules is arranged between the pair of unregulated LED modules.

11. The lighting system of claim 1 further comprising a heatsink mounted to and extending outwardly with respect to the lamp and connected to the multiple LED modules for dissipating heat from the LED system and wherein the heat detection zone is defined within a heated zone of at least one of the multiple LED modules receiving heat energy from the LEDs of at least one of the multiple LED modules wherein the detected temperature inside of the lamp corresponds to a detected temperature of the first LED module

12. The lighting system of claim 11 wherein the heatsink includes a wall defining upper and lower portions and heated zones of adjacent LED modules are on opposing ones of the upper and lower portions of the wall of the heatsink.

13. The lighting system of claim 12 wherein each of the LED modules includes a connector coupling the respective LED module to conductors extending to the control system and wherein the connectors of adjacent LED modules are on opposing ones of the upper and lower portions of the wall of the heatsink.

14. The lighting system of claim 1 further comprising a heatsink having a front wall, and wherein the lamp defines a reflector with a reflector back wall, the heatsink front wall and the reflector back wall in contact with one another so as to transmit heat between each other.

15. The lighting system of claim 14 wherein the reflector back wall includes an opening and the multiple LED modules are arranged within the opening of the reflective back wall in contact with the heatsink.

16. A method of operating a high intensity lighting system to maintain a desired light output level under high temperature operating conditions comprising:
delivering electrical power to a plurality of LED modules of a lamp outputting light at a first lumen output level from the lamp;
detecting a temperature of the lamp during delivery of electrical power;
controlling delivery of electrical power to at least one of the plurality of LED modules when the detected temperature exceeds a threshold temperature until the detected temperature falls below the threshold temperature while maintaining light output from the lamp at a second lumen output level less than the first lumen output level that is at least as great as a minimum lumen output level.

17. The method of claim 16 wherein the electrical power delivery control step comprises reducing electrical power delivered to at least one of the plurality of LED modules when the detected temperature exceeds a threshold temperature until the detected temperature falls below the threshold temperature while delivering enough electrical power to at least one other of the plurality of LED modules to maintain light output from the lamp at or above the minimum lumen output level.

18. The method of claim 16 wherein the electrical power delivery control step comprises stopping delivery of electrical power to at least one of the plurality of LED modules when the detected temperature exceeds a threshold temperature until the detected temperature falls below the threshold temperature while continuing to deliver electrical power to at least one other of the plurality of LED modules maintaining a light output from the lamp that is at or above the minimum lumen output level.

19. The method of claim 16 wherein the lamp is comprised of a plurality of pairs of LED modules and wherein the electrical power delivery control step comprises reducing electrical power delivered to one of the plurality pairs of LED modules when the detected temperature exceeds a threshold temperature until the detected temperature falls below the threshold temperature while delivering enough electrical power to at least a plurality of the plurality of pairs of LED modules to maintain light output from the lamp at or above the minimum lumen output level.

20. The method of claim 16 wherein the lamp is comprised of a plurality of pairs of LED modules and wherein the electrical power delivery control step comprises stopping delivery of electrical power to one of the plurality pairs of LED modules when the detected temperature exceeds a threshold temperature until the detected temperature falls below the threshold temperature while delivering electrical power to a plurality of the plurality of pairs of LED modules to maintain light output from the lamp at or above the minimum lumen output level.

21. The method of claim 16 wherein the temperature detecting step comprises detecting a temperature in a heat detection zone of the lamp encompassing the plurality of LED modules.

22. The method of claim 16 wherein the plurality of LED modules comprises a first LED module and a second LED module attached to a housing of the lamp with one of the first and second LED modules defining a regulated LED module and the other one of the first and second LED modules defining an unregulated LED module, and wherein during the electrical power delivery control step that electrical power delivered to the regulated LED module is reduced based at least in part on the detected temperature while the amount of electrical power delivered to the unregulated LED module is not reduced.

23. The method of claim 22 wherein the temperature detecting step comprises detecting a temperature of a heat detection zone defined upon at least one of the first and second LED modules.

24. The method of claim 23 wherein the heat detection zone is defined within a heated zone of the at least one of the first and second LED modules.

25. A lamp comprising:
a light fixture having a reflector from which light is directed toward a location to be illuminated;
a heatsink extending from the reflector and having a wall facing toward the reflector opening;
multiple LED modules supported by the wall of the heatsink, each of the multiple LED modules including LEDs arranged to project light out of the light fixture opening; and
a detector mounted with respect to the light fixture for detecting a temperature at a heat detection zone within the light fixture.

26. The lamp of claim 25 wherein a first one of the multiple LED modules is controlled based on the detected temperature within the light fixture, and a second one of the multiple LED modules is not controlled based on the detected temperature within the light fixture.

27. The lamp of claim 25 wherein the detector is mounted for detecting a temperature of a first LED module of the multiple LED modules and wherein the first LED module is controlled based on the detected temperature of the first LED module, and a second LED module of the multiple LED modules is not controlled based on the detected temperature of the first LED module.

28. The lamp of claim 25 wherein the multiple LED modules define a pair of unregulated LED modules that are not controlled based on the detected temperature within the light fixture and at least one regulated LED module that is controlled based on the detected temperature within the light fixture.

29. The lamp of claim 28 wherein the at least one regulated LED module is arranged between the pair of unregulated LED modules.
